(19) United States
(12) Patent Application Publication
(10) Pub. No.: US 2020/0273012 A1
(43) Pub. Date: Aug. 27, 2020

(54) MERCHANDISE SALES DATA PROCESSING APPARATUS AND MERCHANDISE SALES DATA PROCESSING METHOD

(71) Applicant: TOSHIBA TEC KABUSHIKI KAISHA, Tokyo (JP)

(72) Inventor: Masahiko SUGIMOTO, Mishima Shizuoka (JP)

(73) Assignee: TOSHIBA TEC KABUSHIKI KAISHA, Tokyo (JP)

(21) Appl. No.: 16/690,249

(22) Filed: Nov. 21, 2019

(30) Foreign Application Priority Data
Feb. 22, 2019 (JP) 2019-030485

(51) Int. Cl. G06Q 20/20; G06K 7/10

(52) U.S. Cl. CPC G06Q 20/208; G06K 7/10366

(57) ABSTRACT

A mode switch changes a mode of a bag (container) into a blue LED turned-on state (first mode) indicative of being settled on a condition that a settlement process is performed by a settlement processor. The mode switch changes the mode of the bag (container) into a white LED turned-on state (second mode) indicative of being unsettled on a condition that an initialization process is performed by an initialization processor.

### CROSS-REFERENCE TO RELATED APPLICATION

This application is based upon and claims the benefit of priority from Japanese Patent Application No. 2019-030485, filed Feb. 22, 2019, the entire contents of which are incorporated herein by reference.

### FIELD

Embodiments described herein relate generally to a merchandise sales data processing apparatus and a merchandise sales data processing method.

### BACKGROUND

For example, when a customer shops at a store such as a supermarket or a convenience store, a basket (a basket to put merchandise before settlement) or a cart (hereinafter referred to as “basket”) is received over the counter. The customer goes around the store and puts the merchandise to be purchased into the basket. When the selection of the merchandise to be purchased is completed, the customer carries the basket containing the merchandise to a settlement location. Then, in a sales data processing apparatus such as a POS terminal disposed at the settlement location, a salesclerk or the customer himself or herself executes the settlement processing related to the merchandise to be purchased. At this time, the salesclerk or customer causes the sales data processing apparatus to read the radio tag attached to the merchandise. The customer then pays for the purchased merchandise. The merchandise for which the settlement process is completed is housed in a shopping bag or temporarily housed in a basket indicating that the merchandise is settled in order to house the merchandise in a bag or the like prepared by the customer.

Therefore, the store needs to prepare a shopping bag to house the settled merchandise. Further, the store needs to prepare two types of baskets in order to distinguish between merchandise before settlement and the merchandise after settlement (for example, JP-A-2018-079090).

### DESCRIPTION OF THE DRAWINGS

FIG. 1 is an external perspective view illustrating an example of a merchandise sales data processing apparatus according to a first embodiment.

FIG. 2 is a front view illustrating a settlement processor (a settlement processing unit).

FIG. 3 is a hardware block diagram illustrating an example of a hardware configuration of a self-checkout point-of-sale (POS) terminal.

FIG. 4 is a hardware block diagram illustrating an example of a hardware configuration of an initialization processing terminal.

FIGS. 5A and 5B are diagrams illustrating an example of a structure of a light emitter.

FIG. 6 is a functional block diagram illustrating an example of a functional configuration of the merchandise sales data processing apparatus.

FIG. 7 is a diagram for explaining information exchanged between the merchandise sales data processing apparatus and an RFID tag.

FIG. 8 is a state transition diagram illustrating an example of a transition of a mode of the light emitter included in a bag.

FIG. 9 is a flowchart illustrating an example of a flow of processing performed by a self-checkout POS terminal according to the first embodiment.

FIG. 10 is a flowchart illustrating an example of a flow of processing performed by the initialization processing terminal according to the first embodiment.

FIG. 11 is a diagram illustrating an example of a basket used in a second embodiment.

FIG. 12 is a functional block diagram illustrating an example of a functional configuration of a merchandise sales data processing apparatus of the second embodiment.

FIG. 13 is a flowchart illustrating an example of a flow of processing performed by a self-checkout POS terminal of the second embodiment.

FIG. 14 is a flowchart illustrating an example of a flow of processing performed by an initialization processing terminal of the second embodiment.

### DETAILED DESCRIPTION

An object of an exemplary embodiment is to provide a sales data processing apparatus and a sales data processing method capable of distinguishing between unsettled merchandise (i.e., merchandise for which a settlement process has not yet been completed) and settled merchandise without the store preparing a shopping bag or two types of baskets.

The merchandise sales data processing apparatus of the embodiment includes a settlement processing unit, an initialization processing unit, and a mode changing unit. The settlement processing unit performs settlement of a merchandise in a state in which a container having a first radio tag houses the merchandise with a second radio tag based on radio tag information read from the second radio tag. The initialization processing unit initializes the container to an unsettled state (a second state) by communicating with the first radio tag. The mode changing unit changes a mode of the container into a first mode indicative of being settled (a first state) on condition that the settlement is performed by the settlement processing unit, and changes the mode of the container into a second mode indicative of being unsettled on condition that the initialization is performed by the initialization processing unit.

### First Embodiment

Hereinafter, a merchandise sales data processing apparatus according to the first embodiment will be described with reference to the drawings. In the first embodiment, a merchandise sales data processing apparatus in which a customer performs settlement by himself or herself for purchased merchandise will be described. The present disclosure is not limited to the embodiments described below.

Description on Overall Configuration of Merchandise Sales Data Processing Apparatus

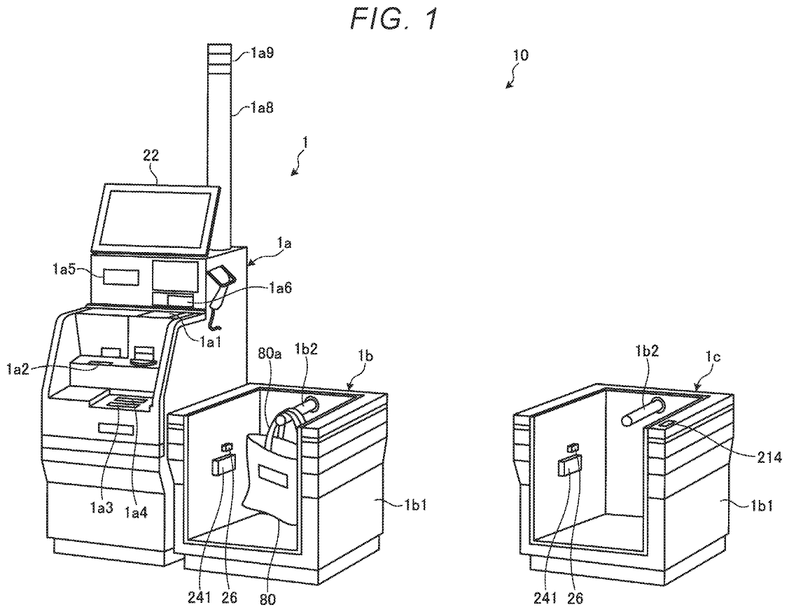

First, the overall configuration of the merchandise sales data processing apparatus will be described. FIG. 1 is an external perspective view illustrating an example of a merchandise sales data processing apparatus (a merchandise sales data processor) 10 according to a first embodiment. As illustrated in FIG. 1, the merchandise sales data processing apparatus 10 includes a self-checkout POS terminal 1 and an initialization processing terminal 1c. The self-checkout POS terminal 1 includes a main body 1a and a settlement processing terminal 1b provided separately from the main body 1a.

The self-checkout POS terminal 1 is a device that performs a sales registration process and a settlement process for a merchandise purchased by a customer by the customer's own operation. The sales registration process is a process of registering merchandise information of a merchandise purchased by a customer in the self-checkout POS terminal 1. More specifically, the self-checkout POS terminal 1 acquires a merchandise code that specifies a merchandise by reading tag information from a radio tag attached to the merchandise. The self-checkout POS terminal 1 reads the merchandise information (such as merchandise name, price) of the merchandise from a merchandise master based on the acquired merchandise code. Furthermore, the self-checkout POS terminal 1 gives a notification to the customer by displaying the read merchandise information and stores the merchandise information.

The settlement process is performed based on the merchandise information stored in the sales registration process by the self-checkout POS terminal 1. More specifically, the settlement process is a process for displaying the total amount and tax amount related to the transaction, a process for calculating and displaying change based on the deposit deposited from the customer, a process for instructing a change machine to issue a change, and a process for issuing receipt on which merchandise information and settlement information (such as total amount, deposit amount, change amount) are printed.

The main body 1a of the self-checkout POS terminal 1 houses a coin change machine, a bill change machine, a power supply unit (a power supply) (all not illustrated), and the like. The main body 1a includes a coin insertion portion (coin receiver) 1a1 for inserting coins deposited from customers, a coin dispensing port 1a2 for dispensing coin changes, a bill insertion portion 1a3 for inserting bills deposited from customers, a bill dispensing port 1a4 for dispensing bill changes, a receipt issuing port 1a5 for issuing a receipt on which merchandise information and settlement information are printed, and a card insertion slot 1a6 into which a card is inserted when settling with the card.

Coins inserted from the coin insertion portion 1a1 are stored in a coin change machine. The self-checkout POS terminal 1 pays out the coin change to be paid out to the customer at the coin dispensing port 1a2 from the coins stored in the coin change machine. The bill inserted from the bill insertion portion 1a3 is stored in a bill change machine. Then, the self-checkout POS terminal 1 pays out the bill changes to be paid out to the customer at the bill dispensing port 1a4 from the bills stored in the bill change machine.

The main body 1a includes a display unit (a display) 22 on the top of the main body 1a. The display unit 22 displays merchandise information and settlement information to the customer. The main body 1a includes a columnar pole 1a8 and includes a patrol lamp 1a9 at the upper end of the pole 1a8. The patrol lamp 1a9 is turned on to call an attendant when an error occurs in the self-checkout POS terminal 1 or when the customer requires assistance (e.g., because the customer does not know the operation of the self-checkout POS terminal 1).

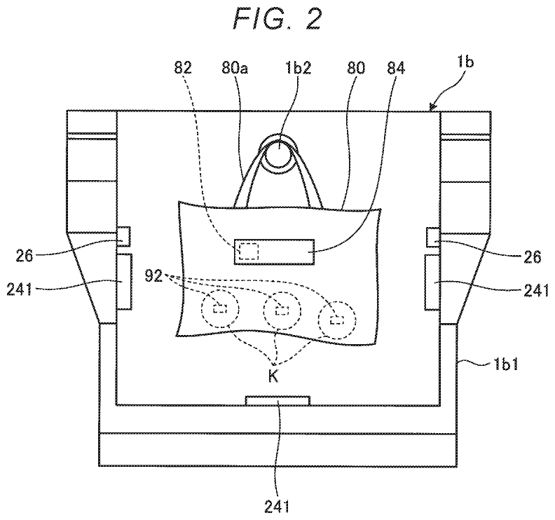

FIG. 2 is a front view illustrating the settlement processing terminal 1b. The settlement processing terminal 1b has a box-shaped main body 1b1 and has a structure in which the front surface and the upper surface are opened. The settlement processing terminal 1b houses a bag 80 owned by the customer, in which merchandise purchased by the customer is housed (that is, the bag 80 is a housing for the merchandise).

The bag 80 is the property of the customer, and the customer himself or herself brings it into the store and houses merchandise K to be purchased. The bag 80 includes a handle 80a. The customer houses the bag 80 in the settlement processing terminal 1b by hooking the handle 80a of the bag 80 containing the merchandise K to be purchased to a rod-shaped support portion 1b2 installed in the settlement processing terminal 1b.

The bag 80 incorporates an RFID tag 82. A light emitter 84 is provided on the surface of the bag 80. In the RFID tag 82, information related to the customer such as an identification number (membership number) for uniquely identifying the customer is registered. The RFID tag 82 is an example of a first radio tag. The light emitter 84 is an example of a light emitting unit.

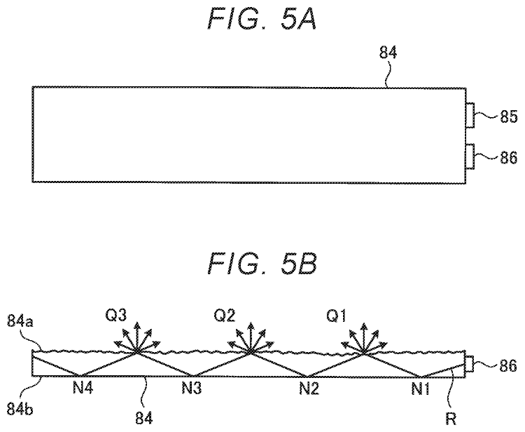

The light emitter 84 is a light guide formed of a light guide member such as polycarbonate, which is installed on the surface of the bag 80 so as to be visible from the outside. For example, light emitted from a light emitting diode (LED) is incident on the light emitter 84. The light incident on the light emitter 84 is guided through the light emitter 84 by repeating a total reflection. Then, surface light is emitted by emitting light from a surface-shaped light emitting portion formed on the surface of the light emitter 84 to the outside. The detailed structure of the light emitter 84 will be described later (FIGS. 5A and 5B).

An RFID tag 92 is attached to the merchandise K that is housed in the bag 80 and purchased by the customer. In the RFID tag 92, an identification number (for example, a merchandise code) that uniquely identifies the merchandise K is registered. The RFID tag 92 is an example of a second radio tag.

A proximity sensor 26 is installed on the side surface inside the settlement processing terminal 1b. The proximity sensor 26 is, for example, a transmissive sensor, one of which is configured by a light emitting unit and the other is configured by a light receiving unit (light receiver). If the light emitted from the light emitting unit is not received by the light receiving unit, the proximity sensor 26 outputs information indicating that the bag 80 hooked on a support portion 1b2 is detected. If the light emitted from the light emitting unit is received by the light receiving unit, the proximity sensor 26 outputs information indicating that no bag 80 hooked on the support portion 1b2 is detected.

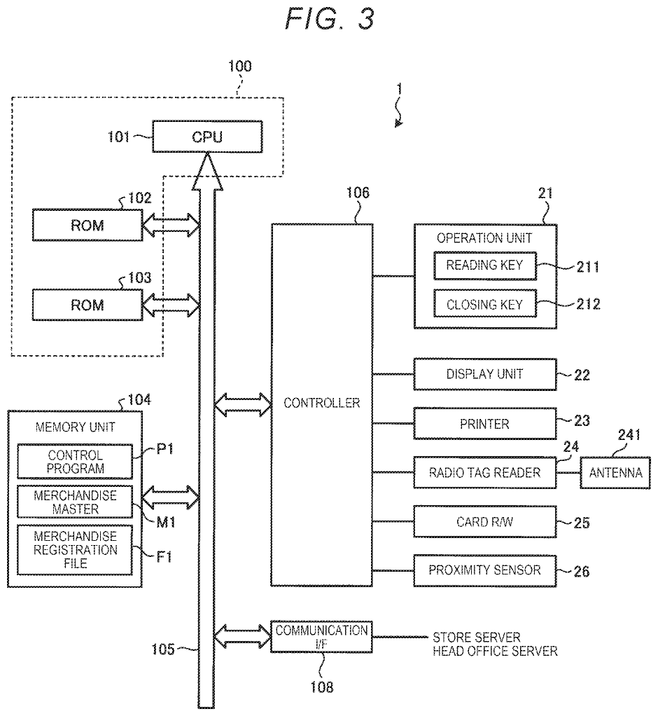

An antenna 241 is installed on the side surface and the bottom surface inside the settlement processing terminal 1b. The antenna 241 is electrically connected to a radio tag reader 24 (see FIG. 3), and transmits radio waves toward the bag 80 and the merchandise K housed in the bag 80. When a signal asking for tag information is received, the RFID tag 92 transmits tag information including merchandise specifying information registered in itself to the settlement processing terminal 1b. Then, the antenna 241 receives the tag information transmitted from the RFID tag 92. In this way, the radio tag reader 24 collectively reads tag information relating to all the merchandises K housed in the bag 80. When a signal asking for the customer's membership number superimposed on the radio wave is received, the RFID tag 82 transmits the membership number registered in the RFID tag 82 itself to the settlement processing terminal 1b. The antenna 241 receives the membership number transmitted from the RFID tag 82. In this way, the radio tag reader 24 acquires member information of the owner of the bag 80.

The RFID tag 82 receives a radio wave radiated from the antenna 241 of the settlement processing terminal 1b, generates an electromotive force, and turns on the light emitter 84, for example, in blue by the generated electromotive force. The RFID tag 82 may receive a radio wave radiated from the antenna 241 of the settlement processing terminal 1b and generate an electromotive force. By the generated electromotive force, the RFID tag 82 may turn on the light emitter 84 in blue, for example, by charging a capacitor or rechargeable battery (not illustrated) included in the bag 80 and discharging the capacitor or rechargeable battery. At this time, the RFID tag 82 may store information indicating that the settlement process is completed by receiving radio waves which are radiated from the antenna 241 of the settlement processing terminal 1b and on which information indicating that the settlement process is completed is superimposed.

Returning to FIG. 1, the initialization processing terminal 1c performs an initialization process of setting the RFID tag 82 included in the bag 80 hooked on the support portion 1b2 to an unsettled state. At this time, the RFID tag 82 receives a radio wave radiated from the antenna 241 of the initialization processing terminal 1c, generates an electromotive force, and by the generated electromotive force, turns on the light emitter 84 to be in a color different from blue, for example, white. At this time, the initialization processing terminal 1c may store, in the RFID tag 82, information indicating that being in an unsettled state.

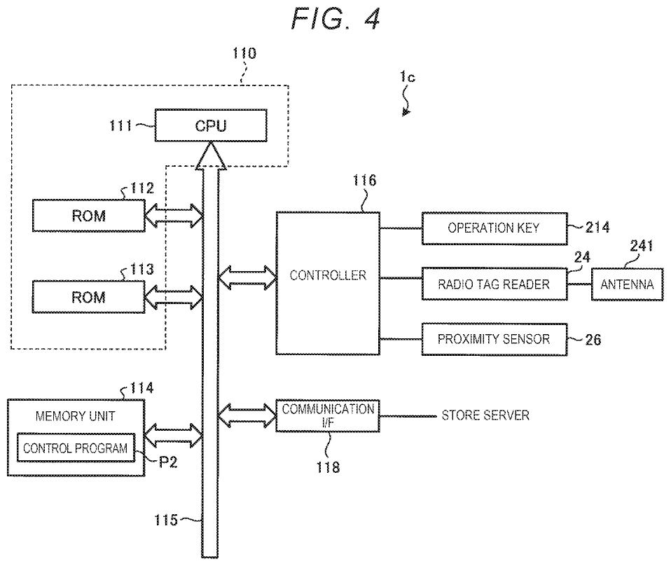

The initialization processing terminal 1c is installed at a position (for example, entrance of store) where customers entering and leaving the store always pass. The initialization processing terminal 1c has substantially the same hardware configuration as the settlement processing terminal 1b, but is different from the settlement processing terminal 1b in that it includes an operation key 214 for instructing the start of initialization. Details will be described later. (FIG. 4). In the present embodiment, a configuration in which a customer operates the operation key 214 to instruct the start of initialization is described, but the operation key 214 is not necessarily provided. That is, the initialization processing terminal 1c may be always in an operating state, and the initialization may be performed when the customer stores the bag 80. Alternatively, a configuration in which the initialization is performed when the proximity sensor 26 similar to that provided in the settlement processing terminal 1b detects the bag 80 may be employed.

Description on Hardware Configuration of Self-Checkout POS Terminal

Next, the hardware of the self-checkout POS terminal 1 will be described. FIG. 3 is a hardware block diagram illustrating an example of a hardware configuration of the self-checkout POS terminal 1. The self-checkout POS terminal 1 includes a control unit 100, a memory unit 104, a controller 106, and a communication interface (I/F) 108.

The control unit 100 includes a central processing unit (CPU) 101, a read only memory (ROM) 102, and a random access memory (RAM) 103. The CPU 101 is connected to the ROM 102 and the RAM 103 via a bus line 105. The CPU 101 develops a control program P1 stored in the ROM 102 or the memory unit 104 in the RAM 103. The CPU 101 controls the operation of the self-checkout POS terminal 1 by operating according to the control program P1 developed in the RAM 103. That is, the control unit 100 has a general computer configuration.

The control unit 100 is further connected to the memory unit 104, the controller 106, and the communication I/F 108 via the bus line 105.

The memory unit 104 is a non-volatile memory such as a flash memory, a hard disk drive (HDD), or the like that retains stored information even when the power is turned off. The memory unit 104 stores a program including the control program P1, and the like. The control program P1 is a program for demonstrating the functions of the self-checkout POS terminal 1.

The control program P1 may be provided by being incorporated in the ROM 102 in advance. The control program P1 may be configured to be provided by being recorded on a computer-readable recording medium such as a CD-ROM, flexible disk (FD), CD-R, digital versatile disc (DVD) in a format that can be installed in the control unit 100 or an executable format. The control program P1 may be stored on a computer connected to a network such as the Internet and provided by being downloaded via the network. Moreover, the control program P1 may be configured to be provided or distributed via a network such as the Internet.

The memory unit 104 stores a merchandise master M1 and a merchandise registration file F1. The merchandise master M1 is a master file that stores merchandise information (such as merchandise code, merchandise name, price) of the merchandise handled at the store. Since the merchandises handled in a store change from day to day, the self-checkout POS terminal 1 uses the communication I/F 108 to acquire the latest merchandise master M1 from a store server or head office server (not illustrated).

The merchandise registration file F1 is a file that stores merchandise information (such as merchandise name and price) of the merchandise purchased by the customer, acquired from the merchandise master M1.

The controller 106 is connected to an operation unit 21, the display unit 22, a printer 23, the radio tag reader 24, a card reader/writer (R/W) 25, and the proximity sensor 26 described herein. The controller 106 controls the operation of various connected hardware based on commands from the control unit 100.

The operation unit 21 is a keyboard or a touch panel including a reading key 211 and a closing key 212. The reading key 211 is a key for starting reading of the RFID tag 92 attached to the merchandise K housed in the bag 80 hooked on the support portion 1b2. The closing key 212 is a key for starting the settlement process for the registered merchandise, and is a key operated when the transaction is completed.

The display unit 22 displays information for customers who operate the self-checkout POS terminal 1. The printer 23 issues a receipt on which sales information is printed on a long sheet. The radio tag reader 24 transmits radio waves from the antenna 241 to the inside of the settlement processing terminal 1b, and receives and reads the tag information of the RFID tag 92 attached to the merchandise K in the settlement processing terminal 1b by the antenna 241. The radio tag reader 24 receives and reads the customer's membership number from the RFID tag 82 with the antenna 241. The card R/W 25 reads card specific information from the card (for example, a credit card) which a customer uses for payment.

The communication I/F 108 communicates with the store server, the head office server (both not illustrated), and other self-checkout POS terminals 1 to receive the latest merchandise master M1 and performs communication such as transmitting information such as a sales file indicating the result of the settlement process to the upper server.

Description on Hardware Configuration of Initialization Processing Terminal

Next, the hardware of the initialization processing terminal 1c will be described. FIG. 4 is a hardware block diagram illustrating an example of a hardware configuration of the initialization processing terminal 1c. The initialization processing terminal 1c includes a control unit 110, a memory unit 114, a controller 116, and a communication I/F 118.

Since the hardware configuration of the initialization processing terminal 1c is the same as the hardware configuration of the settlement processing terminal 1b included in the self-checkout POS terminal 1, only the differences from the settlement processing terminal 1b will be described.

The initialization processing terminal 1c is connected to the operation key 214 via the controller 116. The operation key 214 is a key for instructing the initialization processing terminal 1c to start the initialization process.

The radio tag reader 24 reads tag information transmitted from the RFID tag 92 and received by the antenna 241. The radio tag reader 24 reads the membership number of the customer transmitted from the RFID tag 82 and received by the antenna 241.

The communication I/F 118 communicates with a store server (not illustrated) and performs communication such as transmitting the operation state of the initialization processing terminal 1c to the store server.

Description on Structure of Light Emitting Unit

Next, the structure of the light emitter 84 provided in the bag 80 will be described with reference to FIGS. 5A and 5B. FIGS. 5A and 5B are diagrams illustrating an example of a structure of the light emitter 84.

As illustrated in FIG. 5A, a white LED 85 and a blue LED 86 are installed at the end of the light emitter 84. The white LED 85 and the blue LED 86 are installed such that the emitted light enters the light emitter 84 from the end of the light emitter 84 without leaking.

As illustrated in FIG. 5B, a surface 84a of the light emitter 84, that is, the surface viewed from the outside forms a frosted glass-like diffusion surface. On the other hand, a back surface 84b of the light emitter 84, that is, the side facing the bag 80 forms a smooth surface. As illustrated in FIG. 5B, a light ray R emitted from the blue LED 86 travels inside the light emitter 84 while being repeatedly reflected.

At this time, part of the light reaching the surface 84a is emitted to the outside as diffused light, for example, at points Q1, Q2, Q3, etc. on the surface 84a. Only the light totally reflected by the surface 84a, that is, the light incident at an angle shallower than the critical angle, travels to the back of the light emitter 84. On the other hand, light incident on the back surface 84b at an angle shallower than the critical angle from among the light reached the back surface 84b repeats total reflection on the back surface 84b, for example, at the point N1, N2, N3, N4, etc., and travels to the back of the light emitter 84.

As described above, the light emitter 84 guides the light emitted from the point light source to perform surface light emission. Accordingly, a surface light source having a free shape can be formed, so that display with high visibility can be performed. Illumination using such a light guide is widely used, for example, in backlights of liquid crystal panels.

Description on Functional Configuration of Merchandise Sales Data Processing Apparatus of First Embodiment

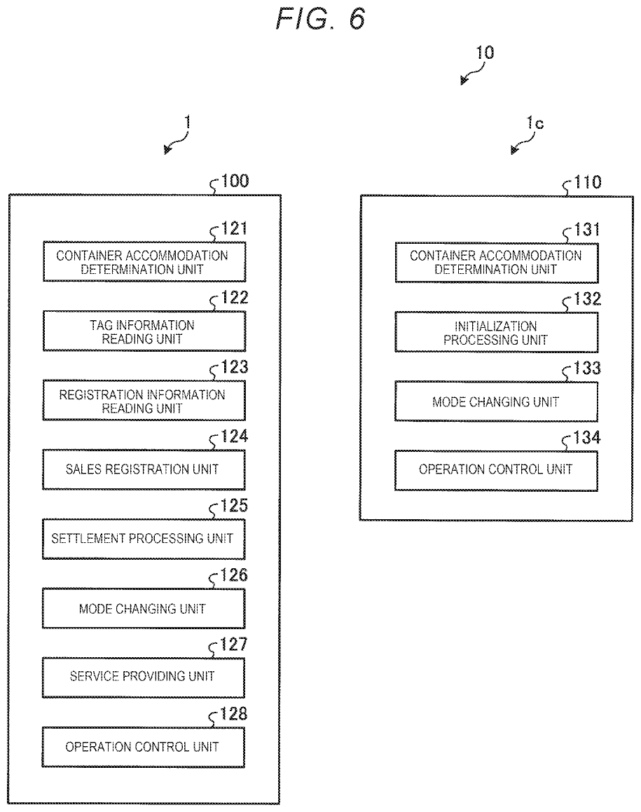

Next, the functional configuration of the merchandise sales data processing apparatus 10 will be described with reference to FIG. 6. FIG. 6 is a functional block diagram illustrating an example of a functional configuration of the merchandise sales data processing apparatus 10. The control unit (controller) 100 of the self-checkout POS terminal 1 implements a container accommodation determination unit 121, a tag information reading unit (tag reader) 122, a registration information reading unit (registration information reader) 123, a sales registration unit (sales registrar) 124, a settlement processing unit (settlement processor) 125, a mode changing unit (mode switch) 126, a service providing unit (service provider) 127, and an operation control unit (operation controller) 128 illustrated in FIG. 6 as functional units by developing and operating the control program P1 in the RAM 103. The control unit 110 of the initialization processing terminal 1c implements a container accommodation determination unit 131, an initialization processing unit (initialization processor) 132, a mode changing unit (mode switch) 133, and an operation control unit (operation controller) 134 illustrated in FIG. 6 as a functional unit by developing and operating control program P2 in the RAM 113.

The container accommodation determination unit 121 determines whether the bag 80 is detected based on the output from the proximity sensor 26. Specifically, the container accommodation determination unit 121 determines whether the bag 80 is detected based on the output from the proximity sensor 26 when the reading key 211 is operated.

The tag information reading unit 122 transmits a radio wave from the antenna 241 when the container accommodation determination unit 121 detects the bag 80, and reads tag information including merchandise specifying information from the RFID tag 92 attached to the merchandise K put in the bag 80.

When the container accommodation determination unit 121 detects the bag 80, the registration information reading unit 123 transmits a radio wave from the antenna 241 and reads the customer member information from the RFID tag 82 included in the bag 80.

The sales registration unit 124 reads the merchandise information from the merchandise master M1 based on the merchandise specifying information read by the tag information reading unit 122, and executes the sales registration process related to the merchandise K put in the bag 80.

The settlement processing unit 125 performs a settlement process for the merchandise K based on the result of the sales registration process. Specifically, for example, when paying with cash, based on the amount of money (bills and coins) entered by the customer and the total amount of the merchandise, if there is change, the change will be paid out, and the receipt on which merchandise information and settlement information (such as total amount, deposit amount, change amount) for the merchandise registered for sales are printed will be issued from the printer 23. At this time, the settlement processing unit 125 may register information indicative of being settled with respect to the RFID tag 82.

The mode changing unit 126 sets the mode of the light emitter 84 of the bag 80 to a state in which the blue LED 86 is turned on and the white LED 85 is turned off on condition that the settlement processing unit 125 performs the settlement process. This mode indicates that the settlement is performed. The state in which the blue LED 86 is turned on and the white LED 85 is turned off is an example of the first mode.

The service providing unit 127 performs a service such as giving points according to the settlement amount to the customer with the membership number read by the registration information reading unit (registration information reader) 123. The given point information is transmitted to the head office server via the communication I/F 108, and the point information of the corresponding customer is updated. Based on the read customer's membership number, the service providing unit (service provider) 127 may acquire and accumulate information related to the customer's shopping (for example, when and what was purchased) in addition to providing the customer with the service, and may reflect the information on the selection of merchandises at the store.

The operation control unit 128 detects a customer's operation on the self-checkout POS terminal 1. For example, the operation control unit 128 detects that the reading key 211, the closing key 212, and the like are operated.

The container accommodation determination unit 131 determines whether the bag 80 is detected based on the output from the proximity sensor 26. Specifically, the container accommodation determination unit 121 determines whether the bag 80 is detected based on the output from the proximity sensor 26 when the operation key 214 is operated.

The initialization processing unit 132 performs initialization process for initializing the bag 80 to an unsettled state by communicating with the RFID tag 82. The initialization processing unit 132 may register information indicating that the initialization is performed with respect to the RFID tag 82 when performing the initialization process.

The mode changing unit 133 sets the mode of the light emitter 84 (an indicator) of the bag 80 to the state in which the white LED 85 is turned on and the blue LED 86 is turned off on the condition that the initialization process is performed by the initialization processing unit 132. This mode indicates that the settlement is not performed. The state in which the white LED 85 is turned on and the blue LED 86 is turned off is an example of the second mode.

Description on Information Exchanged between Merchandise Sales Data Processing Apparatus and RFID Tag

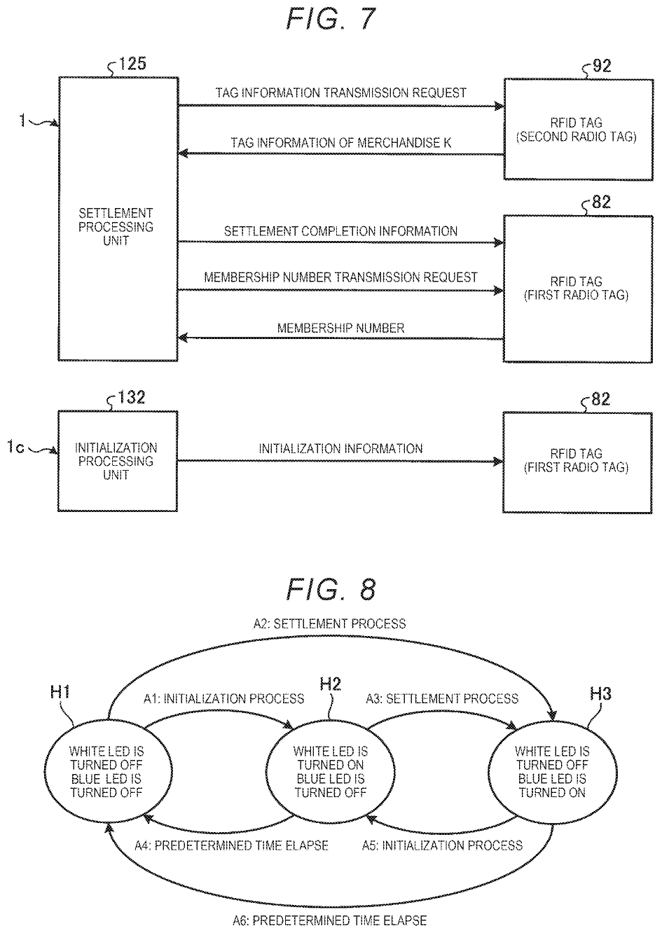

Next, information exchanged with the RFID tags 82 and 92 by the merchandise sales data processing apparatus 10 will be described with reference to FIG. 7. FIG. 7 is a diagram for explaining information exchanged between the self-checkout POS terminal 1 and the initialization processing terminal 1c and the RFID tags 82 and 92 (first and second transmitters).

The settlement processing unit 125 of the self-checkout POS terminal 1 transmits a signal requesting transmission of tag information to the RFID tag 92 (second radio tag or second transmitter). When receiving the tag information transmission request, the RFID tag 92 transmits the tag information of the merchandise K to the settlement processing unit 125.

The settlement processing unit 125 transmits settlement completion information to the RFID tag 82 (first radio tag or first transmitter). When receiving the settlement completion information, the RFID tag 82 turns on the blue LED 86 and turns off the white LED 85. The RFID tag 82 may store information indicating that the settlement is completed when the settlement completion information is received.

The settlement processing unit 125 transmits a signal for requesting transmission of the membership number to the RFID tag 82. When receiving the membership number transmission request, the RFID tag 82 transmits the membership number registered in itself to the settlement processing unit 125.

The initialization processing unit 132 of the initialization processing terminal 1c transmits initialization information to the RFID tag 82. When receiving the initialization information, the RFID tag 82 turns on the white LED 85 and turns off the blue LED 86. The RFID tag 82 may store information indicating that the initialization is completed when the initialization information is received.

Description on Transition of Mode of Light Emitter Included in Bag

Next, the transition of the mode of the light emitter 84 included in the bag 80 will be described with reference to FIG. 8. FIG. 8 is a state transition diagram illustrating an example of a transition of the mode of the light emitter 84 included in the bag 80.

When a customer enters the store, the light emitter 84 of the bag 80 is in a state where both the white LED 85 and the blue LED 86 are turned off, that is, not initialized (state H1).

The customer performs an initialization process using the initialization processing terminal 1c at the store entrance (arc A1). By performing the initialization process, the light emitter 84 of the bag 80 transitions to a state in which the white LED 85 is turned on and the blue LED 86 is turned off, that is, a state indicative of being unsettled (state H2).

When in the state H1, when a customer who fails to execute the initialization process finishes shopping and performs the settlement process at the self-checkout POS terminal 1 (arc A2), the light emitter 84 of the bag 80 transitions to a state where the blue LED 86 is turned on and the white LED 85 is turned off, that is, a state indicative of being settled (state H3). That is, since some customers neglect initialization for some reason, the settlement process can be executed even in the state H1.

When the customer is in the state H2, when the customer finishes shopping and performs the settlement process at the self-checkout POS terminal 1 (arc A3), the state transitions to the state H3.

In the state H2, when a predetermined time elapses (arc A4), the state transitions to the state H1. The predetermined time is, for example, the time until the remaining amount of the rechargeable battery that supplies power to the white LED 85 decreases.

In the state H3, when a customer who performed settlement performs an initialization process using the initialization processing terminal 1c at the store entrance (arc A5), the state transitions to the state H2.

In the state H3, when a predetermined time elapses (arc A6), the state transitions to the state H1.

The merchandise sales data processing apparatus 10 of the present embodiment can change the mode (lighting state) of the light emitter 84 of the bag 80 any number of times between different modes. That is, the customer can use the bag 80 repeatedly.

Description on Flow of Processing Performed by Self-Checkout POS Terminal of First Embodiment

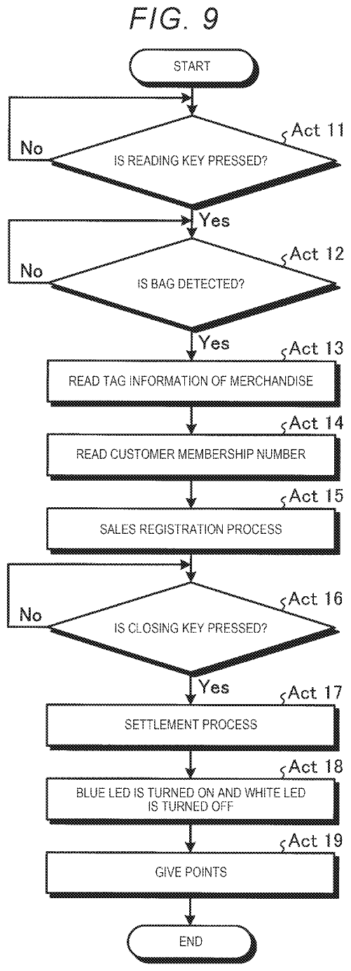

Next, the flow of processing performed by the self-checkout POS terminal 1 will be described with reference to FIG. 9. FIG. 9 is a flowchart illustrating an example of a flow of processing performed by the self-checkout POS terminal 1 according to the first embodiment.

The operation control unit 128 determines whether the reading key 211 is pressed (Act 11). If it is determined that the reading key 211 is pressed (Act 11: Yes), the process proceeds to Act 12. On the other hand, if it is not determined that the reading key 211 is pressed (Act 11: No), Act 11 is repeated.

The container accommodation determination unit 121 determines whether the bag 80 is detected (Act 12). If it is determined that the bag 80 is detected (Act 12: Yes), the process proceeds to Act 13. On the other hand, if it is not determined that the bag 80 is detected (Act 12: No), Act 12 is repeated.

The tag information reading unit 122 reads the tag information of the merchandise K registered in the RFID tag 92 (Act 13).

The registration information reading unit 123 reads the customer membership number registered in the RFID tag 82 (Act 14).

The sales registration unit 124 performs sales registration process (Act 15).

The operation control unit 128 determines whether the closing key 212 is pressed (Act 16). If it is determined that the closing key 212 is pressed (Act 16: Yes), the process proceeds to Act 17. On the other hand, if it is not determined that the closing key 212 is pressed (Act 16: No), Act 16 is repeated.

If it is determined Yes in Act 16, the settlement processing unit 125 performs a settlement process (Act 17). At this time, the RFID tag 82 may store the fact that the settlement process is completed.

The mode changing unit 126 changes the state of the light emitter 84 to a state in which the blue LED 86 is turned on and the white LED 85 is turned off (Act 18).

The service providing unit 127 gives points according to the settlement amount to the member with the membership number acquired in Act 14 (Act 19). Thereafter, the self-checkout POS terminal 1 ends the process of FIG. 9.

Description on Flow of Processing Performed by Initialization Processing Terminal of First Embodiment

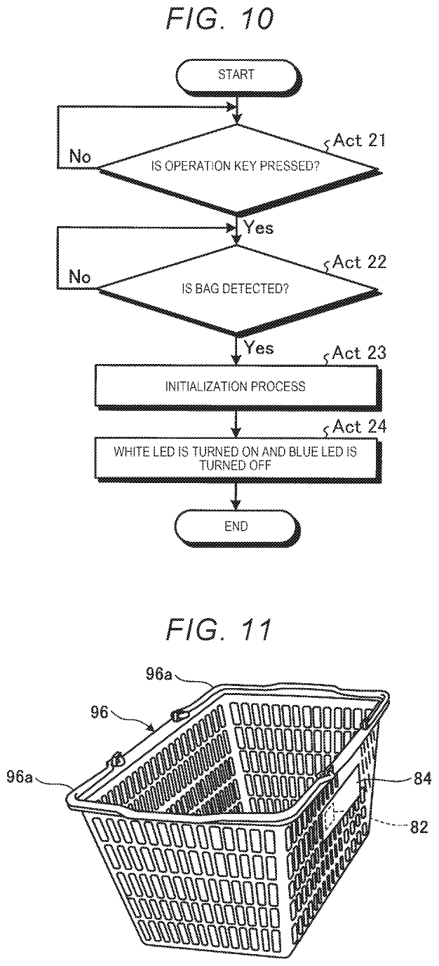

Next, the flow of processing performed by the initialization processing terminal 1c will be described with reference to FIG. 10. FIG. 10 is a flowchart illustrating an example of a flow of processing performed by the initialization processing terminal 1c according to the first embodiment.

The operation control unit 134 determines whether the operation key 214 is pressed (Act 21). If it is determined that the operation key 214 is pressed (Act 21: Yes), the process proceeds to Act 22. On the other hand, if it is not determined that the operation key 214 is pressed (Act 21: No), Act 21 is repeated.

The container accommodation determination unit 131 determines whether the bag 80 is detected (Act 22). If it is determined that the bag 80 is detected (Act 22: Yes), the process proceeds to Act 23. On the other hand, if it is not determined that the bag 80 is detected (Act 22: No), Act 22 is repeated.

The initialization processing unit 132 performs an initialization process for initializing the bag 80 to an unsettled state. At this time, the RFID tag 82 may store the fact that the initialization process is completed (Act 23).

The mode changing unit 133 changes the state of the light emitter 84 to a state in which the white LED 85 is turned on and the blue LED 86 is turned off (Act 24). Thereafter, the initialization processing terminal 1c ends the processing of FIG. 10.

As described above, in the merchandise sales data processing apparatus 10 of the first embodiment, the mode changing unit 126 changes the mode of the bag 80 (container) to the blue LED 86 turned-on state (first mode) indicative of being settled on the condition that the settlement process is performed by the settlement processing unit 125. The mode changing unit 133 changes the mode of the bag 80 (container) to the white LED 85 turned-on state (second mode) indicative of the bag 80 being unsettled on the condition that the initialization process is performed by the initialization processing unit 132. Therefore, it is possible to distinguish between an unsettled state and a settled state in the mode of the bag 80 owned by the customer. As a result, the time and effort required for the settlement process can be shortened because the trouble of replacing the container is reduced. Moreover, the store does not need to prepare shopping bags or two types of baskets. Since the first mode and the second mode can be changed repeatedly any number of times, the bag 80 can be used any number of times.

In the merchandise sales data processing apparatus 10 of the first embodiment, the mode changing units 126 and 133 cause the light emitters 84 (light emitting unit) included in the bag 80 (container) to emit light in any one of the light emission pattern corresponding to the first mode and the light emission pattern corresponding to the second mode. Therefore, the state of settlement can be clearly shown to the salesclerk in the store.

The merchandise sales data processing apparatus 10 of the first embodiment performs the settlement process collectively in a state where the merchandise K is housed in the bag 80 (container) owned by the customer. Information indicating the state of settlement is displayed on the light emitter 84 (light emitting unit) included in the bag 80. Therefore, the customer can make a purchase while storing the merchandise K in the bag 80 that the customer owns, and can make a settlement with the merchandise K housed in the bag 80.

The merchandise sales data processing apparatus 10 according to the first embodiment reads information relating to the customer who owns the bag 80 (container) stored in the RFID tag 82 (first radio tag) included in the bag 80. Therefore, it is possible to provide a service according to the customer such as giving points according to the settlement amount.

### Second Embodiment

Next, a merchandise sales data processing apparatus 10a according to a second embodiment will be described. The merchandise sales data processing apparatus 10a is an example in which a basket 96 provided in a store is used instead of the bag 80 described in the first embodiment. Since the merchandise sales data processing apparatus 10a has a system configuration substantially the same as that of the merchandise sales data processing apparatus 10 described above, the same components are described using the same reference numerals. Description of overlapping functions will be omitted as appropriate.

Description on Configuration of Basket

First, the basket 96 used for the merchandise sales data processing apparatus 10a will be described with reference to FIG. 11. FIG. 11 is a diagram illustrating an example of the basket 96 used in the second embodiment. The basket 96 is an example of a container.

The basket 96 is provided in a store and has the same form as a basket used in a general retail store. A rotatable handle 96a is attached to the upper portion of the basket 96. Similar to the bag 80 described in the first embodiment, the RFID tag 82 and the light emitter 84 are installed on the side surface of the basket 96. The RFID tag 82 receives a radio wave radiated from the antenna 241 of the settlement processing terminal 1b, generates an electromotive force, and turns on the light emitter 84 in blue by the generated electromotive force. The RFID tag 82 receives a radio wave radiated from the antenna 241 of the initialization processing terminal 1c, generates an electromotive force, and turns on the light emitter 84 in white by the generated electromotive force. The RFID tag 82 may store information related to the settlement state (unsettled, settled) of the basket 96. Since the basket 96 is used by an unspecified number of customers, the membership number of the customer described in the first embodiment is not registered in the RFID tag 82. The light emitter 84 has the same function as the light emitter 84 included in the bag 80 of the first embodiment.

Description on Functional Configuration of Merchandise Sales Data Processing Apparatus of Second Embodiment

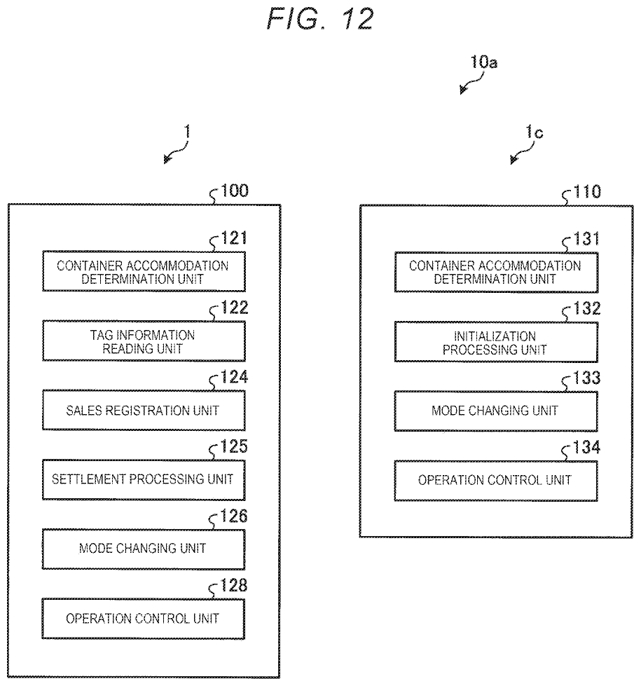

Next, the functional configuration of the merchandise sales data processing apparatus 10a will be described with reference to FIG. 12. FIG. 12 is a functional block diagram illustrating an example of a functional configuration of the merchandise sales data processing apparatus 10a of the second embodiment.

The control unit 100 of the self-checkout POS terminal 1 constituting the merchandise sales data processing apparatus 10a includes the functional units illustrated in FIG. 12. That is, compared with the functional configuration (FIG. 6) of the control unit 100 described in the first embodiment, the configuration is such that the registration information reading unit 123 and the service providing unit 127 are excluded.

The control unit 110 of the initialization processing terminal 1c constituting the merchandise sales data processing apparatus 10a has the same functional configuration (FIG. 6) as the control unit 110 described in the first embodiment.

Description of Operation of Merchandise Sales Data Processing Apparatus of Second Embodiment

Next, the operation of the merchandise sales data processing apparatus 10a will be described. The basket 96 described above is placed in a basket storage area of the store. The initialization processing terminal 1c described in the first embodiment is placed in the vicinity of the basket storage area. When the customer who finished shopping returns the basket 96 to the basket storage area, the person in charge of the store houses the basket 96 returned to the basket storage area in the initialization processing terminal 1c. Then, the initialization processing terminal 1c performs the initialization process described in the first embodiment. At this time, the light emitter 84 of the basket 96 is in a second mode in which the white LED 85 is turned on, that is, unsettled. The basket 96 initialized in this manner is returned to the basket storage area.

A customer who visits the store takes out the initialized basket 96 from the basket storage area. Then, the customer performs shopping while housing the merchandise K in the basket 96. When shopping is completed, the customer houses the basket 96 in the settlement processing terminal 1b. Then, the settlement processing terminal 1b performs the initialization process described in the first embodiment. At this time, the light emitter 84 of the basket 96 is in the first mode in which the blue LED 86 is turned on, that is, the settlement is performed.

The customer who performed settlement in this way returns the basket 96 to the basket storage area and leaves the store. The customer houses the merchandise K in the shopping bag or the like from the settled basket 96 on the loading platform installed in the vicinity of the settlement processing terminal 1b. The initialization processing terminal 1c may be installed in the vicinity of the loading platform, and after the merchandise K is housed in a shopping bag or the like, the customer may perform the initialization process.

Description on Flow of Processing performed by Self-Checkout POS Terminal of Second Embodiment

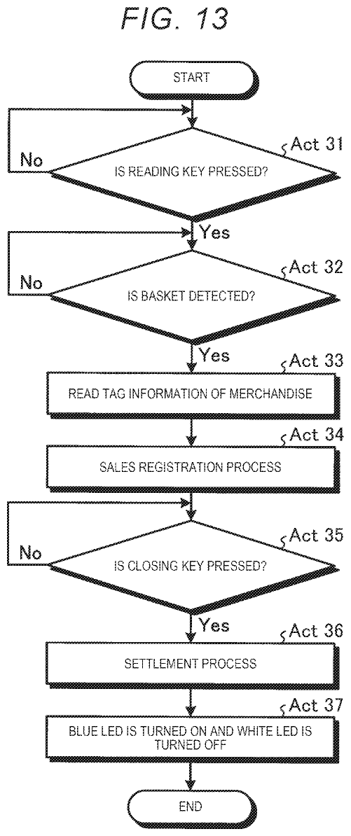

Next, the flow of processing performed by the self-checkout POS terminal 1 will be described with reference to FIG. 13. FIG. 13 is a flowchart illustrating an example of a flow of processing performed by the self-checkout POS terminal 1 of the second embodiment.

The self-checkout POS terminal 1 of the second embodiment performs each process from Act 31 to Act 37 illustrated in FIG. 13. The contents of these processes are obtained by removing the process of acquiring the customer's membership number (Act 14) and the process of giving points to members with the acquired membership number (Act 19) from the processes (FIG. 9) of Act 11 to Act 19 executed by the self-checkout POS terminal 1 of the first embodiment.

Description on Flow of Processing Performed by Initialization Processing Terminal of Second Embodiment

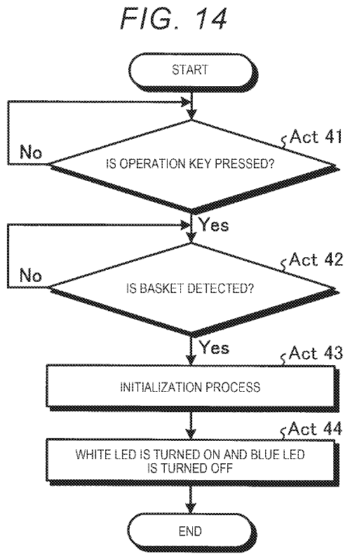

Next, the flow of processing performed by the initialization processing terminal 1c will be described with reference to FIG. 14. FIG. 14 is a flowchart illustrating an example of a flow of processing performed by the initialization processing terminal 1c of the second embodiment.

The initialization processing terminal 1c of the second embodiment performs each process from Act 41 to Act 44 shown in FIG. 14. The contents of these processes are the same as those in Act 21 to Act 24 (FIG. 10) executed by the initialization processing terminal 1c of the first embodiment.

As described above, in the merchandise sales data processing apparatus 10a of the second embodiment, the mode changing units 126 and 133 cause the light emitter 84 (light emitting unit or light indicator) provided in the basket 96 (container) to emit light in one of the first mode indicative of being settled and the second mode indicative of being unsettled. Therefore, the state of settlement can be clearly shown to the salesclerk in the store. With one type of basket 96, it is possible to repeatedly changed and specify the state between the settled state and the unsettled state.

Since the only difference between the bag 80 described in the first embodiment and the basket 96 described in the second embodiment is whether or not the customer's membership number is registered in the RFID tag 82 (first radio tag or first transmitter), the basket 96 can be used in the configuration of the merchandise sales data processing apparatus 10. That is, when the registration information reading unit 123 of the merchandise sales data processing apparatus 10 reads the membership number of the customer from the RFID tag 82 in a state where the basket 96 is housed in the settlement processing terminal 1b, if there is no response from the RFID tag 82, the registration information reading unit 123 may determine that the membership number is not registered. As described above, the merchandise sales data processing apparatus 10 can allow the bag 80 and the basket 96 to be mixed.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A merchandise sales data processing apparatus comprising:
a settlement processor configured to perform settlement of a merchandise within a container including a first radio tag based on radio tag information read from a second radio tag of the merchandise;
an initialization processor configured to initialize the container to a second state by communicating with the first radio tag; and
a mode switch configured to:
change a mode of the container to a first mode indicative of being in a first state in response to the settlement processor performing the settlement; and
change the mode of the container to a second mode indicative of being in the second state in response to the initialization processor performing the initialization.

2. The apparatus of claim 1, wherein the mode switch causes a light emitter included in the container to emit light in a first light emission pattern corresponding to the first mode.

3. The apparatus of claim 2, wherein the mode switch causes the light emitter to emit light in a second light emission pattern corresponding to the second mode different than the first light emission pattern.

4. The apparatus of claim 1, wherein the container is a bag used by a customer.5. The apparatus of claim 4, wherein the first radio tag stores information related to the customer who uses the container.

5. The apparatus of claim 1, wherein the container is an in-store basket.

6. A merchandise sales data processing method, the method comprising:
performing settlement of a merchandise within a container including a first radio tag based on radio tag information read from a second radio tag of the merchandise;
initializing the container to a second state by communicating with the first radio tag;
changing a mode of the container to a first mode indicative of being in a first state in response to the settlement being performed; and
changing the mode of the container to a second mode indicative of being in the second state in response to the initialization being performed.

7. The method of claim 6, wherein the first mode causes a light emitter included in the container to emit light in a first light state corresponding to the first mode.

8. The method of claim 7, wherein the second mode causes the light emitter to emit light in a second light state corresponding to the second mode different than the first light state.

9. The method of claim 6, wherein the container is a bag used by a customer.

10. The method of claim 9, wherein the first radio tag stores information related to the customer who uses the container.

11. The method of claim 6, wherein the container is an in-store basket.

12. A container for collecting merchandise for purchase at a point-of-sale terminal, the container comprising:
a housing for storing the merchandise;
a handle coupled to the housing to assist a customer in carrying the container;
a transmitter coupled to the housing, the transmitter configured to communicate with the point-of-sale terminal; and
an indicator disposed along an exterior of the housing, the indicator configured to transition from a first state indicating that the merchandise has not been purchased via the point-of-sale terminal to a second state indicating that the merchandise has been purchased via the point-of-sale terminal in response to the transmitter receiving an indication regarding a completed purchase of the merchandise from the point-of-sale terminal.

13. The container of claim 12, wherein the container is a bag.

14. The container of claim 12, wherein the container is a basket.

15. The container of claim 12, wherein the transmitter is configured to store information related to the customer and transmit the information to the point-of-sale terminal.

16. The container of claim 12, wherein the indicator includes a light emitter.

17. The container of claim 16, wherein the first state is a first color and the second state is a second color differing from the first color.

18. The container of claim 17, wherein the indicator is configured to transition to a third state after a threshold period of time of being in at least one of the first state or the second state, wherein the third state is an off state.

19. The container of claim 16, wherein the first state is an on state and the second state is an off state.

20. The container of claim 12, wherein the transmitter includes a RFID tag.
